(19) United States
(12) Patent Application Publication
(10) Pub. No.: US 2005/0042421 A1
(43) Pub. Date: Feb. 24, 2005

(54) Multi-layer polymer component, apparatus and method

(76) Inventors: Kurt Schwarzwalder, Macomb, MI (US); Matthew P. Macker, Almont, MI (US); Craig Warren McGinnis, Ortonville, MI (US); Jeffrey Lee Hana, Sterling Heights, MI (US)

Correspondence Address: DYKEMA GOSSETT PLLC, SUITE 300, 39577 WOODWARD, BLOOMFIELD HILLS, MI, 48304, US

(21) Appl. No.: 10/418,784

(22) Filed: Apr. 18, 2003

Related U.S. Application Data
(63) Continuation-in-part of application No. 10/090,683, filed on Mar. 4, 2002, now abandoned.

(51) Int. Cl. B32B 3/10

(52) U.S. Cl. 428/137; 428/139

(57) ABSTRACT

A process and apparatus utilize a multi layer material and a section molding process in which a multi layer length of material having a primary layer and at least one additional layer has a portion that is section molded through a zone heating method creating a molten zone in at least the primary layer. The molten zone is aligned with a section mold to mold only that portion of the multi layer length of material. The section molded portion cools forming a section molded feature. Although exemplary multi-layer components are described herein, a variety of components may be produced utilizing the apparatus and method described by varying the shape of either the primary layer, the at least one additional layer, or the section molded component, or all.

This application is a continuation in part of U.S. Non-Provisional application Ser. No. 10/090,683 filed on Mar. 4, 2002.

### FIELD OF INVENTION

This invention relates generally to a process and apparatus for forming a component including thermoplastic material, and the component produced thereby. More specifically, the process and apparatus utilize a multi-layered length of material in which a portion of the multi-layered material is section molded.

### BACKGROUND

Forming components out of polymer materials may be accomplished by any one of a number of distinct forming techniques such as compression molding, blow molding, injection molding, extrusion molding, and casting.

Compression molding typically involves placement of a specified amount of solid polymer into a heated mold. The heat of the mold surface melts the polymer causing the material to become viscous and conform to the mold shape. Thermoplastic polymers typically require that pressure must be maintained as the piece is cooled so the formed article will retain its shape. The article must be sufficiently cooled before it is dimensionally stable enough to be removed from the mold, affecting production time of the article. This can be a significant disadvantage in high volume production of thermoplastic components.

Injection molding is among the more widely used techniques for fabricating thermoplastic components. Molten plastic is impelled through a nozzle into an enclosed mold cavity where cooling begins to take place almost immediately. Pressure is maintained until the plastic has solidified. The mold is opened and the piece is ejected. Solidification of thermoplastic parts is faster with this method providing, relatively short cycle times.

Extrusion of plastic material takes place as molten polymer is forced through at least one die orifice. To solidify the molten polymer blowers, water spray or submersion may be provided. A calibrator may also be used to shape the extrusion. The calibrator may be in the shape of a short or long tube or a series of disk shaped dies with an orifice, through which the extrusion passes, forming the profile to its final shape. Extrusion molding is well suited to production of continuous lengths of material with a constant cross-sectional shape. Traditional methods of extrusion will not produce a continuous length of material having discontinuities in the cross section or a non-uniform cross section along its length. Co-extrusion takes place when multiple extrusions of two or more materials are combined.

Blow molding occurs when a measured amount of polymer is extruded to form a tube shape. Before the tube extrusion cools, the tube extrusion is placed in a two-piece mold having the desired shape. Air is blown under pressure into the extrusion forcing the tube walls to conform to the contours of the mold.

Casting occurs when polymeric material is poured into a mold and allowed to solidify. For thermoplastics, solidification occurs upon cooling from the molten state.

A wide variety of automotive components are formed from plastic polymer material. One specific example of such a component is a seal capable of direct attachment to a structure, such as a door seal capable of direct attachment to a vehicle body or vehicle door. Door seals may be installed using fasteners or stapling operations. However, installation requires the step of retaining the seal against the structure while numerous fasteners are inserted. Use of fasteners adds handling cost, additional parts, and additional part numbers to the assembly process. Another attachment method involves the use of a seal in combination with adhesive between the seal and the vehicle frame or door frame. This method requires surface treatment of the vehicle frame or door frame before the adhesive can be applied, an undesirable step in the assembly process. Adhesives are available that do not require special surface treatment, but have increased expense. Another alternative, entails use of an extruded seal having a C-channel integrated into the extrusion. The C-channel is attached to the edge of the body sheet metal or to the edge of door panels. The C-channel seal is formed with a relatively complex extrusion. Due to the nature of the molten extrusion process and retention of the shape as the extrusion is cooled, concerns with dimensional repeatability from one component to another persist, this can affect its attachment to the vehicle body or door frame or increase in part rejection. Still, this design has been accepted due to the ease of assembly that it provides. Alternative designs have been unavailable due, in part, to the limitations of known forming techniques for such components.

The invention described herein overcomes the problems in forming a plastic component having a generally complex cross section along its length and provides, by way of example, a process for producing an improved door seal for a vehicle door. The process is suitable for wide application in forming plastic components having a complex cross section and for doing so in a commercially desirable manner.

### SUMMARY OF INVENTION

This invention relates generally to a process and apparatus for forming a component including thermoplastic material, and the component produced thereby. More specifically, the process and apparatus utilize an extrusion and zone molding process in which a polymeric material is extruded, shaped and cooled to form a primary extrusion having a shaped length of uniform cross section, zone heating is then applied to only a portion of the primary extrusion creating a molten zone in that portion, the molten zone is aligned with a section mold to mold only that portion of the primary extrusion. The portion section molded cools quickly forming a section molded portion. The process forms components in a reduced amount of time. The process can be quickly adapted to design changes and requires little in the way of equipment maintenance. Although an exemplary polymeric components are described herein, a variety of other components may be produced utilizing the apparatus and method described herein by varying the shape of either the primary extrusion component or the section molded component, or both.

According to one embodiment, each step occurs in-line, resulting in a continuous process capable of more efficiently producing components than would be accomplished by stretch-forming, injection molding or compression molding of the entire article. According to one embodiment, the primary extrusion is advanced inline so that a plurality of positions on the continuous extrusion can be sequentially zone heated and molded. In an alternative embodiment, a plurality of positions on the continuous extrusion are zone heated to create a plurality of molten zones and the plurality of molten zones are simultaneously molded.

The resulting components are produced at a higher rate, at lower cost and have improved dimensional uniformity from piece to piece. Other aspects of the present invention are provided with reference to the figures and detailed description of embodiments provided herein.

### BRIEF DESCRIPTION OF DRAWINGS

FIG. 1 is an isometric view of an exemplary plastic component;

FIG. 2 is an isometric view of an embodiment of a section mold unit;

FIG. 3A is a cross sectional view of a section mold operation;

FIG. 3B is a cross sectional view of a section mold operation;

FIG. 3C is a cross sectional view of a section mold operation;

FIG. 4 is a side view of an exemplary plastic component;

FIG. 5 is a bottom view of an exemplary plastic component formed with the described process;

FIG. 6 is an illustration of a section molding operation;

FIG. 7 is an embodiment of the process of the present invention;

FIG. 8 is a schematic representation of an in-line manufacturing process of the present invention;

FIG. 9 is a top view of a portion of a primary extrusion;

FIG. 10 is an isometric view of a section mold unit;

FIG. 11 is a side view of a section mold operation;

FIG. 12A is a cross-sectional view of an exemplary plastic component;

FIG. 12B is a side view of an exemplary plastic component;

FIG. 12C is a cross-sectional view of an exemplary plastic component;

FIG. 13 is a cross-sectional view of an exemplary plastic component;

FIG. 14 is a cross-sectional view of an exemplary plastic component;

FIG. 15A is a cross-sectional view of an exemplary plastic component;

FIG. 15B is a top view of an exemplary plastic component;

FIG. 15C is an isometric view of an exemplary plastic component;

FIG. 16 is an isometric view of an exemplary multi layer component;

FIG. 17 is an isometric view of an embodiment of a section mold unit;

FIG. 18A is a cross sectional view of a section mold operation;

FIG. 18B is a cross sectional view of a section mold operation;

FIG. 18C is a cross sectional view of a section mold operation;

FIG. 19 is a side view of an exemplary multi layer component;

FIG. 20 is a bottom view of an exemplary multi layer component formed with the described process;

FIG. 21 is an illustration of a section molding operation;

FIG. 22 is an illustration of a section molding operation;

FIG. 23 is an illustration of a section molding operation;

FIG. 24 is an illustration of a section molding operation;

FIG. 25 is an illustration of a section molding operation;

FIG. 26 is an illustration of a section molding operation;

FIG. 27 is an illustration of a section molding operation;

FIG. 28 is a side view of a portion of a multi layer component;

FIG. 29 is an embodiment of the process of the present invention;

FIG. 30 is a schematic representation of an in-line manufacturing process of the present invention;

FIG. 31 is a top view of a portion of a primary extrusion;

FIG. 32 is an isometric view of a zone heat unit;

FIG. 33 is a side view of a zone heat operation;

FIG. 34 is a top view of a multi layer component;

FIG. 35 is a side view of a multi layer component; and

FIG. 36 is a cross sectional view of a mold for a multi layer component.

### DETAILED DESCRIPTION

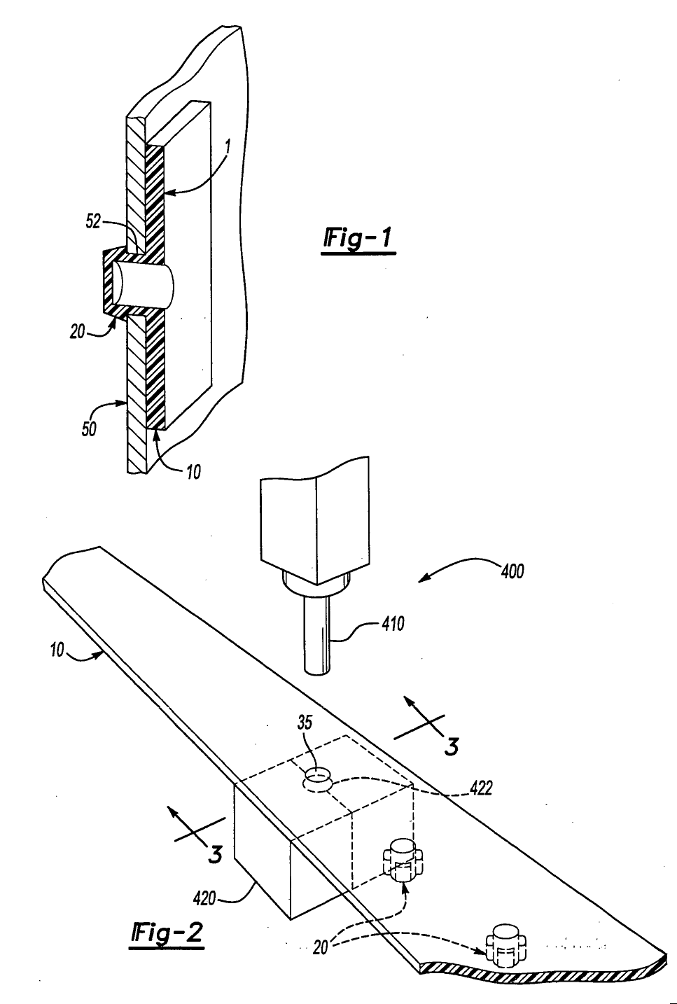

It is desirable to develop a process for forming a plastic polymeric component having a complex cross section suitable for attachment to structure such as a vehicle body. A variety of devices and process were experimented with in an effort to form such a component. One novel process was successful. An exemplary component resulting from this process is shown in FIG. 1. The process used to form the component, provides short cycle time, can be quickly adapted to design changes, and is entirely automated.

FIG. 1 illustrates an embodiment of an exemplary polymeric component I formed into a polymeric door seal having a primary extrusion 10 formed into the shape of an elongated seal and section molded portion 20 formed into the shape of a barbed snap. The primary extrusion 10 may be formed into any of a variety of cross sections. The section mold feature has variable wall thickness, variable outer diameter and variable cross sectional shape. The section molded portion 20 is formed after the primary extrusion 10 by zone heating a portion of the primary extrusion 10 to create a molten zone within the primary extrusion 10. The section molded portion 20 is then compressed into a die cavity until the section molded portion 20 takes the shape of the die cavity and forms a solid state while remaining integral to the primary extrusion 10. The process for manufacturing the exemplary component provides components that are dimensionally uniform and which have a cross-section more complex than attained with plastic drawing techniques. The process also provides a shorter cycle time than compression molding and injection molding techniques, and is less complex in nature than vacuum molding or blow molding techniques. The process eliminates material waste associated with trimming operations.

The section molded portion 20 may be formed to be more or less rigid than the primary extrusion 10. In the exemplary polymeric component 1, the section molded portion 20 extending from the primary extrusion 10 is more rigid in order to serve as a fastener providing secure attachment of the primary extrusion to a mating structure 50 such as the vehicle frame or vehicle door panel. As shown in FIG. 1, the section molded feature 20 is capable of interconnection with an aperture 52 in the mating structure 50 and has sufficient rigidity to retain the primary extrusion 10 relative to the mating structure 50.

Although an exemplary polymeric component 1 in the form of a polymeric door seal having a primary extrusion 10 in the form of an elongated seal and a section molded portion 20 in the form of a barbed snap are discussed, a wide variety of components may be produced with the apparatus and method described herein by varying the shape of either the primary extrusion component 10 or the section molded component 20, or both.

FIG. 10 is a view of a zone heating unit 300 heating a portion of a primary extrusion 10 to form a molten zone 35 in that portion, leaving at least a portion of the surrounding primary extrusion 10 in the solid state. Here, a primary extrusion 10 is fed into a zone heating unit 300. Zone heating unit 300 includes at least one zone heating element 310. In this embodiment, opposing zone heating elements 310 are aligned proximal upper 15 and lower 16 surfaces of the primary extrusion 10. The zone heating unit 300 may include heat elements 310 of a variety of types. In this embodiment, zone heating elements 310 are solid metal elements heated to about 700 degrees Fahrenheit. Heating elements 310 are placed proximal the upper and lower surfaces of the primary extrusion 10 at any suitable distance, but do not touch either surface. In one embodiment, heating elements 310 are placed as close in distance to the primary extrusion 10 as tolerances will allow without contacting the primary extrusion 10. In another embodiment, conductive heating elements 310 are placed directly in contact with the plurality of surfaces 15, 16 of the primary extrusion 10. In addition, other forms of heating elements 310 may be used and are contemplated within the scope of the invention including without limitation, convection heating units that direct heated air over the primary extrusion, infrared heating units, and induction heating heating units.

Once a molten zone 35 is formed between the heating elements 310, the primary extrusion is advanced and an additional portion of the primary extrusion 10 heated to repeat the process. In an alternative embodiment, heating elements may be provided in more than one location along the length of the primary extrusion 10 to simultaneously heat more than one portion of the primary extrusion, simultaneously forming more than one molten zone 35, while leaving surrounding portions of the primary extrusion 10 in the solid state.

FIG. 11 is a side view of a zone heating unit 300 incorporating an aligning mechanism 320 for accurately aligning the primary extrusion 10 relative to the zone heating elements 310. In this embodiment heating elements 310 are aligned proximal a plurality of surfaces 15, 16 of the primary extrusion 10, but do not contact the surfaces 15, 16. Molten zone 35 is formed between the heating elements 310. In this embodiment, the aligning mechanism is in the form of upper surface guide 325 and lower surface guide 326. Each surface guide includes an aperture 327 and 328 to provide for positioning of the heating elements 310 in close proximity to the upper and lower surfaces 15, 16 of the primary extrusion 10. Lower surface guide 326 and upper surface guide 325 provide sufficient clearance for the primary extrusion to pass between while maintaining tight tolerance between the surfaces of the primary extrusion 10 and each heating element 310. Although an aligning mechanism 320 in the form of a surface guide is discussed, other alignment mechanisms are contemplated and within the scope of the invention including without limitation channel guides, roller guides or other form of guide to accurately position the primary extrusion 10 relative to zone heating elements 310.

FIG. 2 is a view of a section mold unit 400 having a pressing unit 410 and a die 420 having a die cavity 422. In this embodiment, the die 420 is held in a stationary position. A portion of the primary extrusion 10 includes a molten zone 35. Once the portion of the primary extrusion 10 having the molten zone 35 is aligned over the die cavity 422, the pressing unit 410 is actuated to exert a downward force on the material in the molten zone 35 pressing the viscous material into the cavity 422. The viscous material associated with the molten zone 35 flows sufficiently to fill the cavity 422.

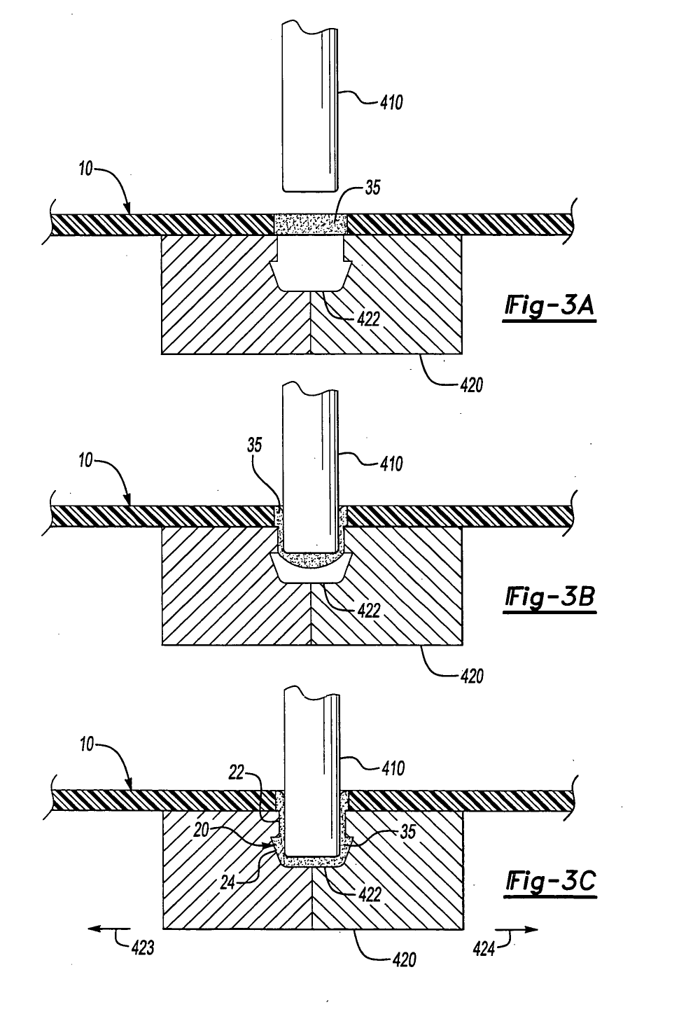

FIG. 3A is a cross sectional view of an embodiment of a section mold operation. As described in reference to FIG. 3, the portion of the primary extrusion 10 aligned over the cavity 422 forms a molten zone 35, while the surrounding portion of the primary extrusion 10 is in a solid state. Pressing unit 410, provided in the form of a mandrel, is positioned over the cavity 422. The die 420 is provided as a split die.

FIG. 3B is a cross sectional view in which the pressing unit 410 begins to compress the portion of the primary extrusion 10 having a molten zone 35. Here, the portion of the primary extrusion 10 having the molten zone 35 begins to take the shape of the die cavity 422 while remaining integral to the primary extrusion 10.

FIG. 3C is a cross sectional view in which the pressing unit 422 is in a fully extended position and has fully compressed the portion of the primary extrusion 10 having the molten zone 35. The primary extrusion 10 material completely fills the mold cavity 422 and conforms to the shape of the pressing unit 410 and the die cavity 422, while remaining integral to the primary extrusion 10. The material in the mold cavity 422 quickly becomes solid state. According to one embodiment, the pressing unit 410 and die 420 are at a lower temperature than the molten zone 35 being pressed. This aids in cooling the section molded portion 20 at a higher rate. In another embodiment, the pressing unit 410 is about the same temperature as the molten zone. This can aid in flow within the die cavity 420 and reduce part wear. In yet another embodiment, the pressing unit 410 is at a temperature greater than the molten zone 35. The section mold feature has variable wall thickness, variable outer diameter and variable cross sectional shape. The section molded feature 20 in this embodiment has an initially thin walled portion 22, and a thicker walled portion 24 with angular projections forming a barbed snap feature. The die 420 of this embodiment is a split die. The split die 422 is parted in the direction of arrows 423 and 424, releasing the exemplary plastic component 1. The result is a primary extrusion 10 with an integral section molded portion 20 having a dimensionally repeatable shape with a cross-section more complex than attained with plastic drawing techniques, and capable of formation faster than compression mold, vacuum mold, or injection mold techniques.

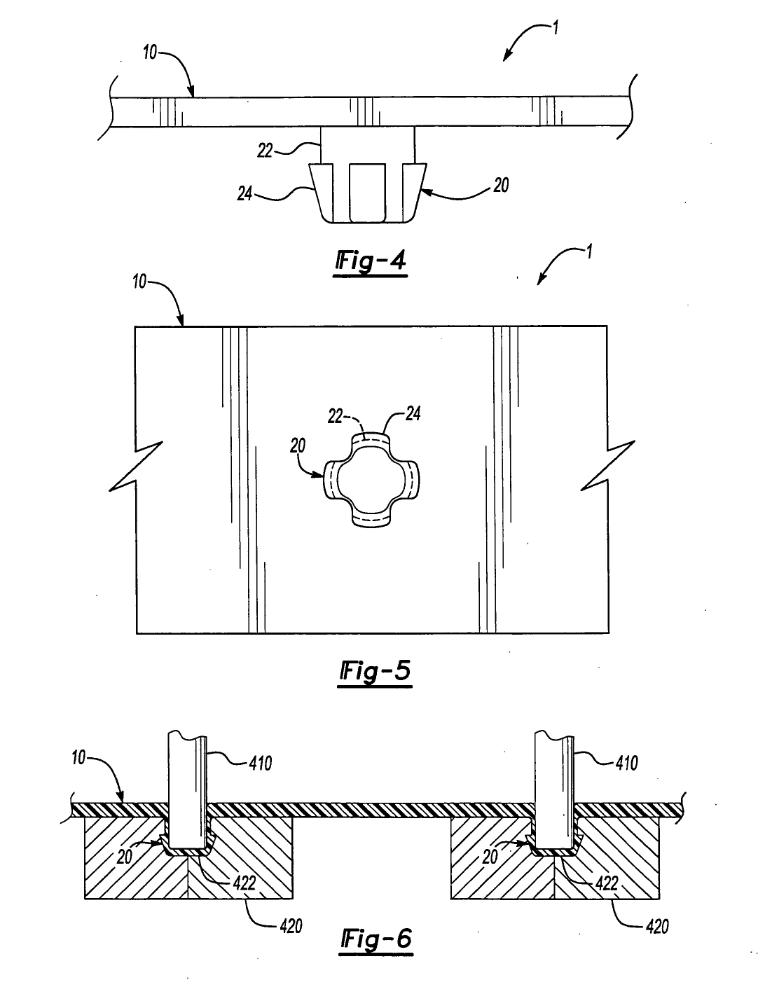

FIG. 4 is a side view of an exemplary plastic component 1 after removal from the section mold unit 400 of FIG. 2. The exemplary plastic component 1 includes a primary extrusion 10 in the form of an elongated extrusion and a section molded portion 20 in the form of an integral barbed snap having an initially thin walled portion 22 and thicker walled portion 24 with angular projections 26.

FIG. 5 is a bottom view of an exemplary polymeric component 1 formed with the described process. The exemplary plastic component 1 includes a primary extrusion 10 in the form of an elongated extrusion and a section molded portion 20 in the form of an integral barbed snap having an initially thin walled portion 22 and thicker walled portion 24 with angular projections 26.

FIG. 6 is an illustration of an alternative embodiment of a section molding operation. In this embodiment, the section mold 400 includes a plurality of pressing units 410 and a plurality of dies 420. A primary extrusion 10 is simultaneously zone heated along a plurality of positions along its length, providing a plurality of molten zones 35. A plurality of section molded portions 20 are formed simultaneously according to this embodiment.

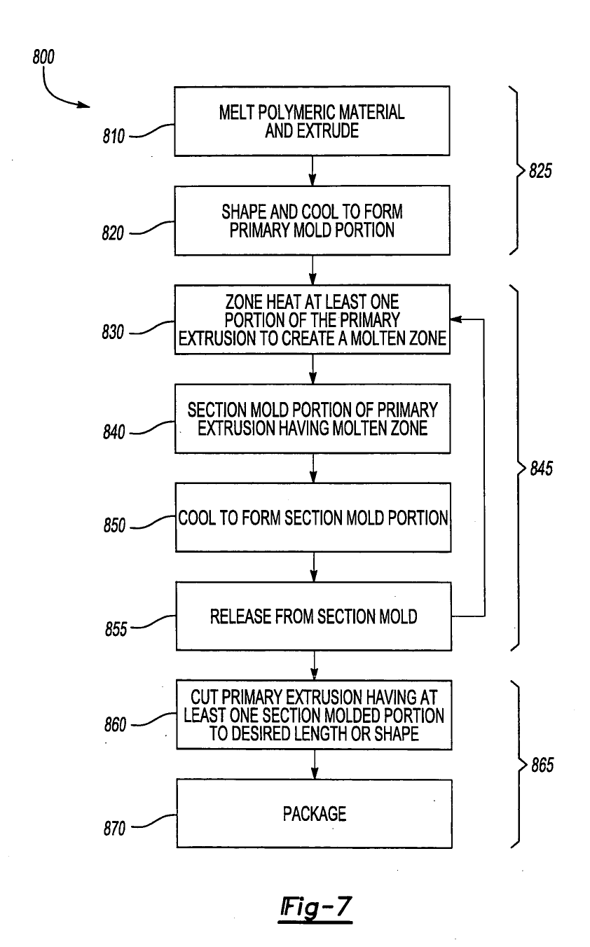

FIG. 7 is an embodiment of the process of the present invention 800. The primary extrusion process 825 includes extrusion of a molten remeltable polymer 810. The extruded polymer is then shaped and cooled 820 to form the primary extrusion 10. The section molded process 845 includes zone heating of at least one portion of the primary extrusion to create a molten zone 830, leaving the surrounding portions in a solid state. Then section molding the portion having the molten zone 840 and cooling the section molded portion 850 as described herein to form the section molded portion 20. The section molded portion 20 is then released from the section mold unit 855. The packaging process 865 includes cutting the polymeric component to the desired length 860 to form the exemplary component 1, described herein, and dropping the exemplary component 1 directly into a package 870 for shipping. According to one embodiment, the steps described in process 800 occur in-line. In another embodiment, the primary extrusion 10 having at least one section molded portion 20 can be cut to a desired shape.

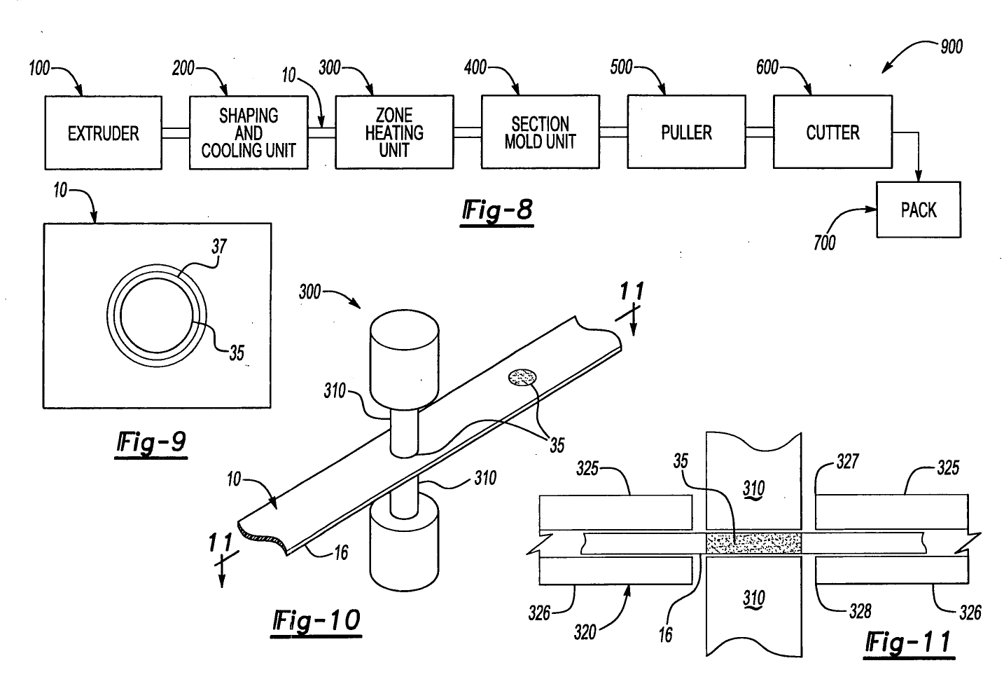

FIG. 8A is a schematic representation of an embodiment of an apparatus 900 that performs the process of the present invention 800 in-line. The apparatus 900 forms the exemplary component 1 described herein with lower cycle time than can be accomplished with other methods. An extruder 100 is utilized to melt polymeric material and force the material through an orifice. Extruders 100 typically utilize a screw mechanism to place the molten material under pressure. The pressure forces the molten material through an orifice at the exit of the extruder 100. The shape of the orifice can establish the shape of the extrusion. The extrusion directly enters the shaping and cooling unit 200 to form the primary extrusion 10. The cooled primary extrusion 10 exits directly to the zone heat unit 300. The zone heat unit 300 is utilized to zone heat at least one portion of the primary extrusion 10 to form a molten zone 35 therein, leaving the surrounding portions in a solid state. The in-line process of this embodiment, does not require a conveyer to carry the primary extrusion 10. Instead, a puller 500 acts on a portion of the primary extrusion 10 to pull the continuous primary extrusion 10 through the zone heat unit 300 as it exits the cooling and shaping unit and then on to the section mold unit 400 as it exits the zone heating unit 300. Pullers are generally known in the art and typically include an upper re-circulating track and a lower re-circulating track that pull an extrusion through frictional contact between surfaces of the tracks and the extrusion. According to this embodiment, the primary extrusion 10 is processed in one continuous piece from the initial extrusion form exiting the extruder 100, through the shaping and cooling unit 200, through the zone heating unit 300, through the section mold unit 400, through the puller 500, until reaching the cutter 600 where it is cut to form the final component. The puller in this embodiment utilizes a soft foam belt that conforms to some degree around the section molded portion 20. The arrangement of the extruder 100, cooling unit 200, zone heating unit 300, section mold unit 400, puller 500, and cutter 600 eliminates the need for a conveyer and reduces cycle time by providing direct feed from one unit to another.

The shape of the extruder 100 exit orifice can take any one of a variety of shapes including without limitation, rectangular, C-shaped, tubular, rounded aperture, square aperture, or any combination thereof. The shaping and cooling unit 200 may utilize a variety of cooling methods including without limitation, air cooling, water spray, submersion. The zone heating unit 300 may include heat elements of a variety of types. Heat elements may be located proximal one surface or proximal a plurality of surfaces of the primary extrusion. Alternatively, heat elements may be placed in direct contact with one or more surfaces of the primary extrusion 10. The zone heating unit 300 may utilize any of a variety of types of heat sources, including without limitation, radiant heating, conductive heating, convection heating, infrared heating, and induction heating. According to the invention, an alignment mechanism in the form of surface guides, channel guides or any other form of guide may be used to accurately position the primary extrusion 10 relative to zone heating elements. The section mold unit 400 applies a compression force for pressing the molten zone 35 into the die cavity 422 and applies a retraction force for removing the pressing unit 410. The section mold unit 400 utilizes a pressing unit 410 that can be interchanged with a pressing unit 410 having a different dimension and shape, and utilizes a die unit 420 that can be interchanged with a die comprised of a single piece die, split piece die or other formation. The cutting unit 600 includes a cutter that cuts the final extrusion to any desired length. In an alternative embodiment, the cutter 600 includes a shaped cutting unit that cuts the primary extrusion 10 having at least one section molded portion 20 to any desired shape, including without limitation round, square, or rectangular shapes.

To form exemplary component 1, thermoplastic polymer pellets are fed into the extruder 100. Initially, molten material from the extruder may be cooled in the cooling unit without sizing blocks, the initial extrusion exits the cooling unit, and is fed into the puller. Once engaged with the puller, additional shaping in the cooling unit is accomplished by setting split sizing blocks around the extrusion. The extruder 100 continues to melt pellets and extrude the material through a an exit orifice. In this embodiment a rectangular horizontally elongated exit orifice is used to form an initial extrusion having a thickness of about 2 mm. The cooling unit is a water submersion tank with a series of block forms about 1 inch wide having a central rectangular sizing aperture corresponding to the final desired shape of the extrusion exiting the exit orifice. The block forms help to support the extrusion and retain its shape during cooling. A primary extrusion having a thickness of about 2 mm exits the shaping and cooling unit. The puller 500 acts at a constant intermittent speed on the 2 mm thick extrusion to pull the extrusion through the zone heat unit 300, through the section mold unit 400, through the puller 500 and out to the cutter 600. The zone heat unit 300 includes surface guides for accurately positioning the extrusion relative zone heating elements 310 having solid metal heating elements. The zone-heating unit 300 includes upper and lower zone heat elements 310, each set to about 700 degrees Fahrenheit. Heating elements are each positioned close to the primary extrusion 10, but not in contact with, the upper and lower surface of the primary extrusion 10 for about 4 seconds to heat a portion of the primary extrusion 10 to its molten state. The section mold unit 400 actuates to press a pressing unit 410 in the form of a mandrel into at least one portion of the primary extrusion 10 having a molten zone, pressing the material into the die cavity 422 and retracting with a cycle time of about 1 second. The primary extrusion 10 with section molded portions 20 is then cut to the desired length of several feet and is dropped into a package. The process according to this embodiment is fully automated. In an alternative embodiment, the line is arranged as described, except that an increased line speed is achieved by locating a series of opposing zone heat elements within the zone heating unit along the path of travel of the primary extrusion 10, collectively heating one portion of the primary extrusion 10 to create a molten zone. For example, a plurality of heat elements would be stationed to heat a given portion of the primary extrusion for a time in the range of about 1 second each, to allow the primary extrusion 10 to advance to match a 1 second cycle time of the section mold unit 400. In this manner, the cycle time is not limited by the time for one set of heat elements to heat one portion of the primary extrusion 10. Heating units 300 utilizing heating elements set to a higher temperature or using other methods of heating may be used to further reduce cycle time.

In an alternative embodiment, the section molded portion 20 is formed off line from the formation of the primary extrusion 10. A primary extrusion is provided, and is fed into a zone heating unit 300. While FIG. 8 relates to a continuous inline process for forming both the primary extrusion 10 and the section molded portion 20 inline, an off line process is also contemplated and within the scope of the invention.

FIG. 9 illustrates the portion of the primary extrusion 10 having the molten zone 35, in more detail. Thermal gradients 37 extend through the adjacent material aiding in the transition between the primary extrusion 10 and the integral section mold 20. The primary extrusion being heated, may be formed from a single extrusion or may be a co-extruded piece.

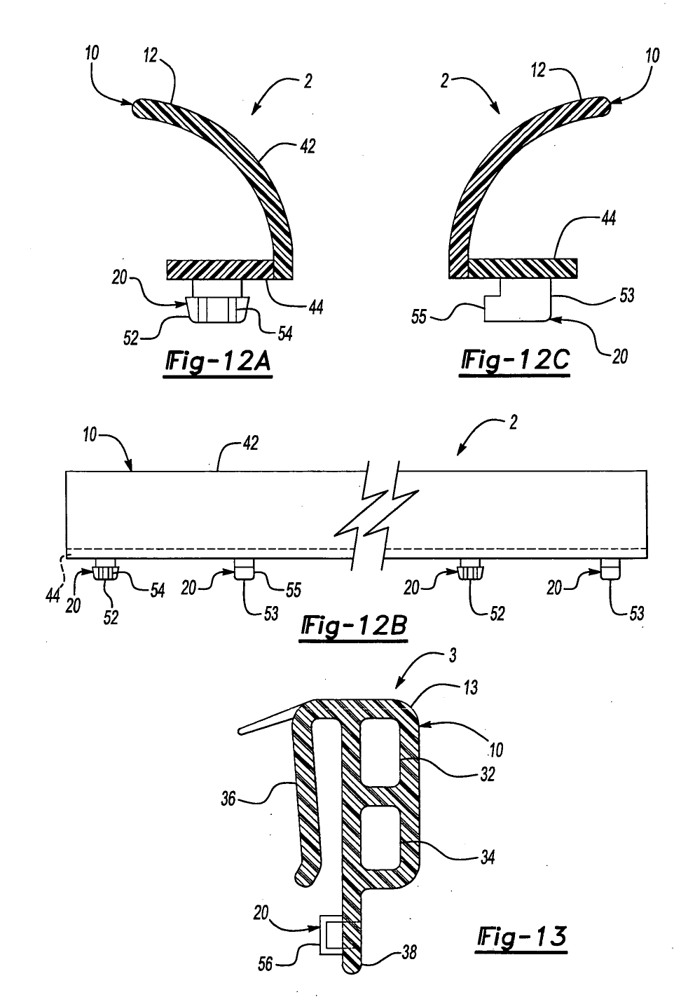

FIG. 12A is a cross-sectional view of an exemplary polymer component 2 having a primary extrusion 10 having a crescent shaped co-extruded cross-section 11 in which the curved portion 42 of the primary extrusion 10 is formed from a polymer different from the polymer used to form the base portion 44, the separate extrusions are fed through a single die where they are co-extruded to form a single part, then shaped and cooled in a conventional manner. Both polymers need not be thermoplastic as thermoplastic material can be co-extruded with non-thermoplastic material. In one embodiment, both portions of the extrusion are formed from thermoplastic materials. The curved portion of the extrusion is formed from a thermoplastic elastomer, and the straight portion of the extrusion is formed from talc-filled polypropylene. In another embodiment, a thermoplastic material is co-extruded with a non-thermoplastic material to form a primary extrusion 10. The curved portion of the extrusion is formed from a non-thermoplastic polymer, and the straight portion of the extrusion is formed from polypropylene. In one embodiment, section molded portions 20 are formed into corrugated fasteners 52 and tabbed fasteners 53 along the base portion 44 according to the process described herein. Accordingly, at least one section molded portion 20 in exemplary component 2 differs in shape from at least one other section molded portion. More specifically, some section molded portions 20, form corrugated fasteners 52 having angled corrugations 54 utilizing a pressing unit 410 in the form of a mandrel having a corrugated shape and a die cavity 422 having a corrugated shape corresponding to the shape of the mandrel. Other section molded portions 20, form tabbed fasteners 53 with tabs 55 projecting outwards utilizing a split die cavity 422 having a shape corresponding to a tab. FIG. 12B is a side view of the exemplary polymer component 2 with a plurality of evenly spaced section molded portions 20, 21. FIG. 12C is a cross sectional view showing section molded portion 20 formed into tabbed fasteners 53 with tabs 55.

FIG. 13 is a cross-sectional view of an exemplary polymer component 3 having a primary extrusion 10 having a co-extruded cross-section 13 in the form of a set of channels 32 and 34 as well as clip feature 36 formed of a polymer different than the polymer of the extension 38. At least one section molded portion 20 is formed along the length of extension 38. In this embodiment, section molded portion 20 is formed in the shape of a projection 56 for positioning the extrusion during assembly, but does not act as a fastener. In one embodiment, thermoplastic elastomer material of a certain durometer forms channels 32 and 34 and clip feature 36 and is co-extruded with polyproylene material to form extension portion 38. In another embodiment, non-thermoplastic material forming channels 32 and 34 and clip feature 36 is co-extruded with thermoplastic material forming extension portion 38.

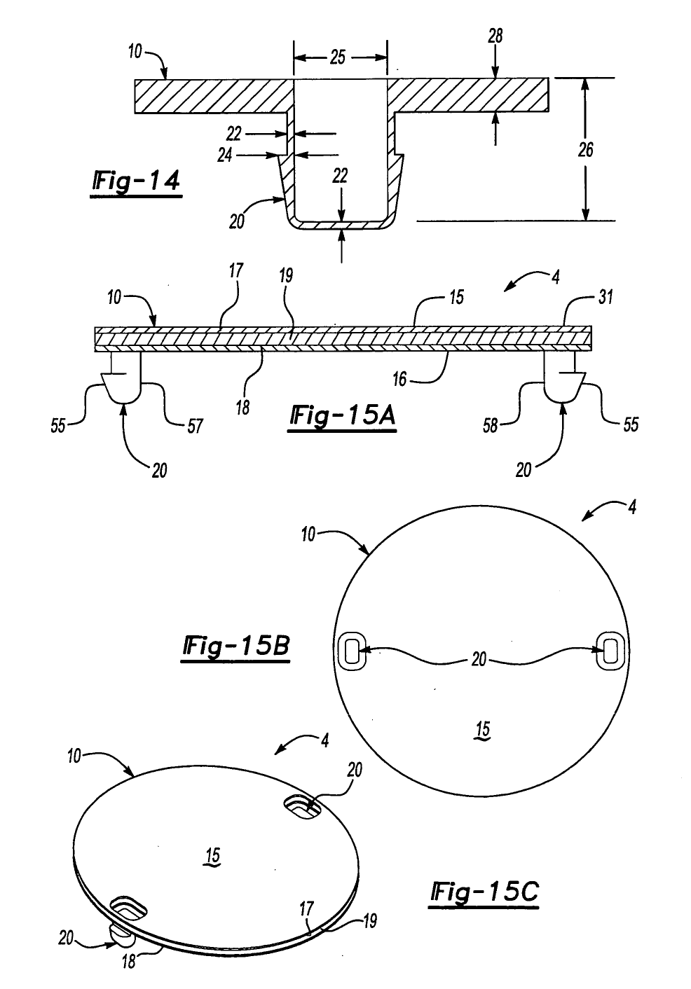

FIG. 14 is a cross sectional view of a section mold feature 20. According to this embodiment, the primary extrusion 10 and section-molded portion 20 are formed of a thermoplastic material such as 20% talc-filled polypropylene, a low cost thermoplastic common in automotive components. The primary extrusion is formed to have a 2 mm thickness 28. From that, a barbed snap having about a 0.6 cm inner diameter, and about a 0.05 cm thin walled 22 portion, and a 0.1 cm thick walled 24 portion and a 0.85 cm inner length 26 is formed by applying an insertion force of about 5.5 lb and an extraction force of about 23 lb.

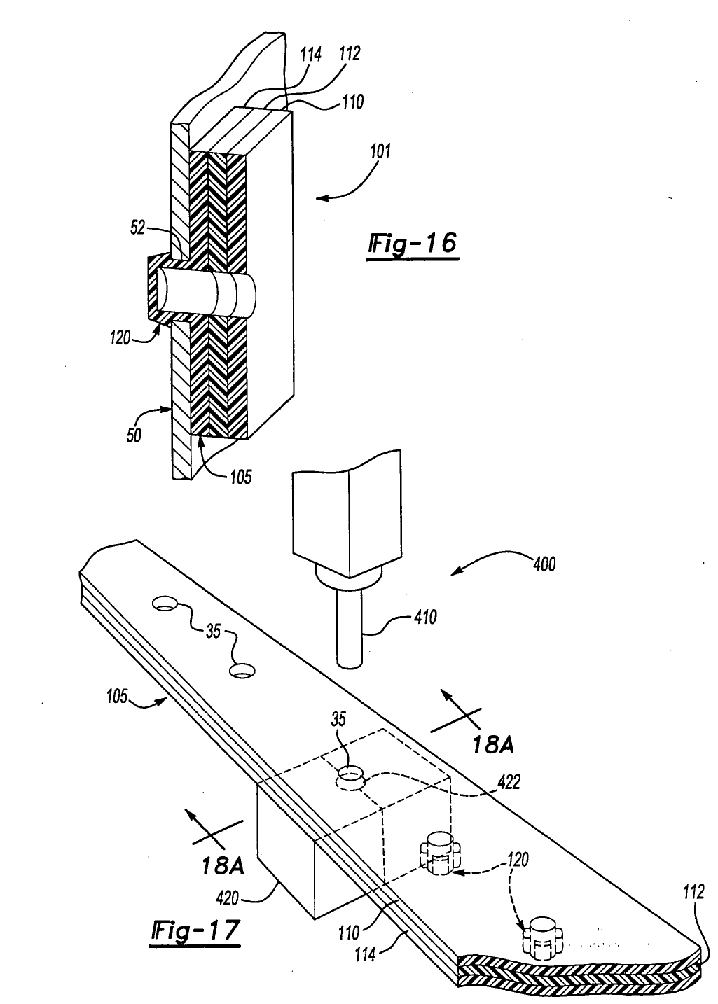

FIG. 15A is a side view of an exemplary component 4, in which the co-extruded cross-section 31 is formed of a layered co-extrusion. According to this embodiment, one polymer is extruded to form upper 17 and lower 18 layers while a different polymer is extruded to form central layer 19 to form a primary extrusion 10 in the form of a co-extruded layered sheet. The co-extruded sheet has upper surface 15, and lower surface 16. The co-extruded sheet is zone heated, and section molded as described herein. A cutting unit with a circular cutter is used to cut the primary extrusion 10 having section molded portions 20 into circular exemplary component 4. Exemplary component 4 is then dropped into a package for shipping. Exemplary plug component 4, includes section molded portions 20 in the form of opposing tab fasteners 57, 58 with tab portions 55 extending outward from one another. Opposing tab fasteners 57, 58 act against the edge of an aperture in the mating structure, creating a retentive fit within the aperture. In an alternative embodiment, opposing tabs 57, 58 may snap into individual apertures corresponding to each tab to create a retentive fit. In this embodiment, section molded portions 20 are formed into tabs 57, 58 utilizing pressing units 410 in the form of substantially rectangular mandrels, and dies 420 having split die cavities 422 corresponding to a tab shape. FIG. 15B is a top view of exemplary component 4 having upper surface 15, and primary extrusion 10 having section molded portions 20 cut into a circular component. FIG. 15C is an isometric view of exemplary component 4 showing primary extrusion portion 10 with section molded portions 20 cut into a circular component. In one embodiment, the primary extrusion is formed with a thermoplastic elastomer of a certain durometer co-extruded with talc-filled polypropylene to form a co-extruded sheet having upper and lower layers formed of thermoplastic elastomer and a center layer of talc-filled polypropylene.

Although exemplary polymeric components are described with respect to FIGS. 1 through 15C, a variety of other components may be produced utilizing the apparatus and method described herein by varying the shape of either the primary extrusion component, or the section molded component, or both. Such components may include without limitation, wire harness organizers with integral fasteners, and trim hole plugs with integral fasteners.

It is contemplated that the present invention include use of a primary extrusion 10 having at least a portion formed of a thermoplastic material including without limitation: 20% talc-filled polypropylene, talc-filled polypropylene, polyethylene, soft or rigid TPE, nylon, ABS/PVC. As used herein, molten refers to the heated state at which the thermoplastic is sufficiently viscoelastic to flow into the die cavity 422 under pressure from the pressing unit 410 into the desired final shape. The primary extrusion 10, may be extruded of a single thermoplastic material or co-extruded with other thermoplastic or non-thermoplastic material.

In an alternative embodiment, the primary extrusion 10 may be replaced by a primary plastic component formed by other methods, including without limitation compression molding, injection molding, blow molding, casting. The section mold operation may then be utilized on such a piece to form a section mold portion 20 in that piece.

FIG. 16 illustrates an embodiment of an exemplary multi-layered polymeric component 101. The multi layer polymeric component is formed from a multi layer length of material 105 having a primary layer 110 and at least one additional layer 112 of material. The multi-layer length of material 105 further includes a section molded feature 120 integral with at least the primary layer 110. In this embodiment, the section molded feature 120 is formed into the shape of a barbed snap. The multi-layer length of material 110 and the section molded feature 120 may be formed into any of a variety of cross sections. The primary layer 110 may be formed by either the primary extrusion 10 previously described or the primary extrusion may be replaced by a non-extruded material made by other methods including without limitation, compression molding, injection molding, blow molding, and casting.

In addition, the multi-layered length of material 105 may be formed with a variety of material interfaces which retain the primary layer 105 to the at least one additional layer 112, 114. For instance, the,multi-layer length of material 105 may be formed by utilizing various methods to affix at least one additional layer 112 to the primary layer 110 including: section molding a section mold feature 120 to retain at least two layers in relation to one another, by applying adhesive between at least two layers, by heat bonding at least two layers, by mechanically fastening at least two layers, or by any combination thereof. A section mold feature 120 suitable for use with a mating structure is then formed integral with at least the primary layer 110. According to one embodiment, the multi layer polymer component forms a door seal such as would be suitable for use on a vehicle.

FIG. 32 illustrates a method for forming the multi layer component 101 having a section molded feature 120. This Figure provides a view of a zone heating unit 300 in which a portion of the multi-layer length of material 105, including at least a portion of the primary layer 110, is zone heated to form a molten zone 35 while at least a portion of the surrounding primary layer 110 remains in a solid state. The multi-layered length of material 105 is fed into a zone heating unit 300. The zone heating unit 300 includes at least one zone heating element 310. In this embodiment, opposing zone heating elements 310 are aligned proximal upper 15 and lower 16 surfaces of the multi-layer length of material 120. A molten zone 35 is formed in at least a portion of the primary layer 110 by the heating elements 310. According to one embodiment, the step of zone heating includes creating a molten zone 35 in less than the entire thickness of the primary layer, improving processing time. In additional embodiments, the step of zone heating may include heating through the entire thickness of the primary layer 110, or may include heating portions of more than one layer in the multi-layer length of material 105 to create a molten zone portion 35 within at least two thermoplastic layers, leaving surrounding portions of the multi-layer length of material 105 in a solid state. The step of zone heating at least one portion of the multi-layer length of material 105 may further include applying zone heating of the type selected from the group consisting of: convection heating, radiant heating, conduction heating, infrared heating, and induction heating.

FIG. 33 is a side view of a zone heating unit 300 incorporating an aligning mechanism 320 for accurately aligning the multi-layer length of material 105 relative to the zone heating elements 310. In this embodiment, the aligning mechanism is in the form of upper surface guide 325 and lower surface guide 326. The molten zone portion 35 may then be formed into a section molded feature 120 in a section mold unit. A portion of multi-layered length of material including the section molded feature is then cut into a final component shape and packaged.

FIG. 17 is a view of a section mold unit 400 having a pressing unit 410 and a die 420 with a die cavity 422. In this embodiment, the die 420 is held in a stationary position. A portion of the multi-layer length of material 105, including a portion of the primary layer 110, includes a molten zone 35. Once the molten zone 35 is aligned over the die cavity 422, the pressing unit 410 is actuated to exert a downward force on the material in the molten zone 35, pressing the viscous material into the cavity 422. The viscous material associated with the molten zone 35 flows sufficiently to fill the cavity 422. According to one embodiment, the die cavity 422 may be provided in a split die 420 having a combined shape corresponding to the outer shape of a barbed projection to be section molded from at least the primary layer 110, and the pressing unit 410 may be provided to be comprised of an upper mandrel having a shape corresponding to the inner shape of the barbed projection. After compressing or forcing the molten zone 35, the mandrel may be raised and the split die 420 separated to release the multi-layer length of material.

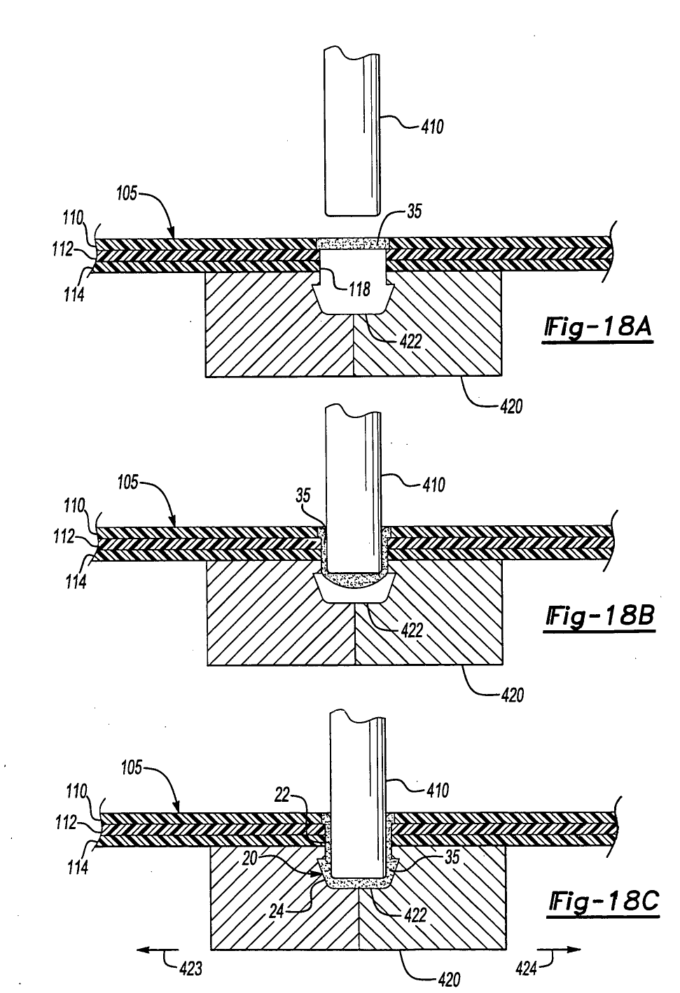

FIG. 18A is a cross sectional view of an embodiment of a section mold operation. The portion of the multi-layer length of material 105 having the molten zone 35 is aligned over the die cavity 422, while the surrounding portion of the primary layer 110 is in a solid state. The pressing unit 410, provided here in the form of a mandrel, is positioned over the cavity 422. The die 420 is provided as a split die. Here, the portion of the primary layer 110 having the molten zone 35 is forced through at least one additional layer 112, 114 and begins to take the shape of the die cavity 422 while remaining integral to at least the primary layer 110, the molten zone 35 cools more quickly as it represents only a portion of the component being formed, thereby forming the section molded feature 120.

FIG. 18B is a cross sectional view in which the pressing unit 410 begins to compress the portion of the multi-layer length of material 105, including the portion of the primary layer 110, having a molten zone 35. Here, the portion of the multi-layer length of material 105 having the molten zone 35 begins to take the shape of the die cavity 422 while remaining integral to at least the primary layer 105.

FIG. 18C is a cross sectional view in which the pressing unit 422 is in a fully extended position and has fully compressed the portion of the multi-layer length of material 105 having the molten zone 35. The molten zone portion 35 of the multi-layer length of material 110 completely fills the mold cavity 422 and conforms to the shape of the pressing unit 410 and the die cavity 422, while remaining integral to at least the primary layer 110. The result is a multi-layer length of material 105 with an integral section molded portion 120 having a dimensionally repeatable shape with a cross-section more complex than attained with plastic drawing techniques, faster cooling, and capable of formation faster than compression mold, vacuum mold, or injection mold techniques.

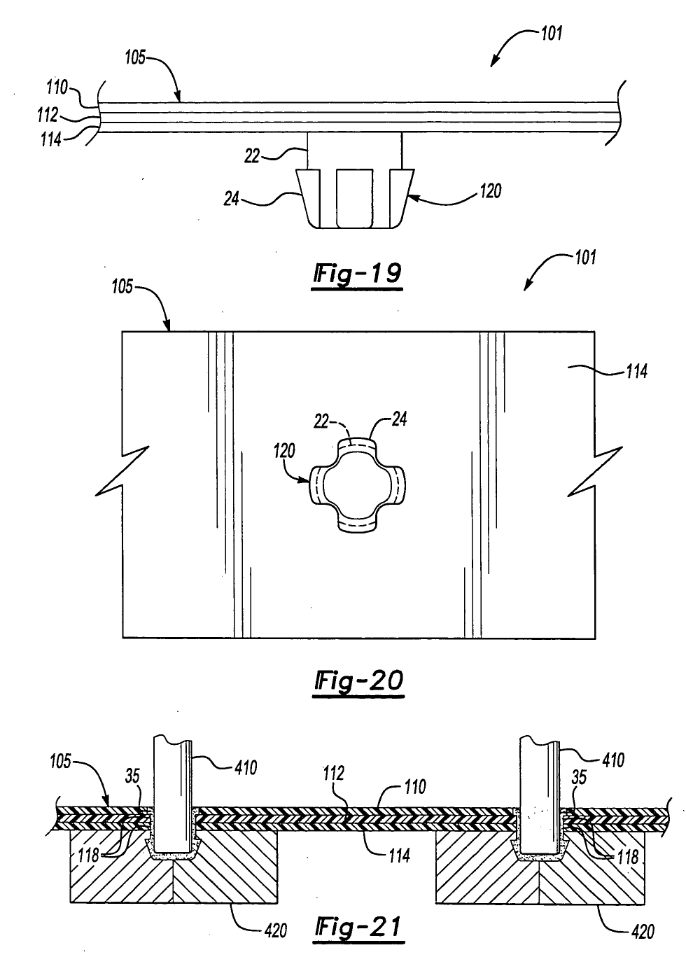

FIG. 19 is a side view of an exemplary plastic component 101 after removal from the section mold unit 400 of FIG. 17. The multi-layer component 101 is formed from a multi-layered length of material 105 including a primary layer 110 formed at least in part by thermoplastic material, at least one additional layer of material 112 is fixedly attached to the primary layer 110, and a section molded feature 120 formed at least in part from the primary layer 110.

FIG. 20 is a bottom view of an exemplary polymeric component formed with the described process.

According to one embodiment, the multi layer component includes a primary layer 110 of thermoplastic material such as 20% talc-filled polypropylene. An additional layer, here a middle layer 112, is formed of a stiffening layer of thermoplastic material. And a second additional layer 114, here an outer layer, is formed of a soft-durometer anti-rattle layer that directly contacts a surface of the mating structure 50.

According to other embodiments, the at least one additional layer may include without limitation, a stiffening layer, a soft durometer anti-rattle layer, an adhesive layer, a sealing layer, an electrically conductive plastic layer, a metal layer including an electromagnetic shield layer or a metal foil layer, or any combination thereof. According to one embodiment, at least one of the additional layers may have at least one aperture 118. The additional layer having the aperture 118 may further be formed of a non-thermoplastic material or a non-polymeric material.

According to one embodiment, an anti-rattle component may be formed from the multi layer length of material 105 including a primary layer 110 and at least one additional layer, here an outer layer 114, having a durometer lower than the primary layer making the component suitable for an anti-rattle interface with a mating structure when the secondary mold feature is received in a mating structure.

According to another embodiment, a sealing component may be formed from the multi layer length of material 105 including a primary layer 110 and at least one additional layer, here an outer layer 114, of sealing material suitable for providing a sealed interface with a mating structure when the secondary mold feature is received in a mating structure. According to one embodiment, the sealing material is suitable for sealing the interface with the mating structure to substantially prevent the passage of water through the interface. According to one embodiment, the sealing material is suitable for sealing the interface with the mating structure to substantially prevent the passage of undesired sound through the interface. According to one embodiment, the sealed interface is achieved by incorporating at least one additional layer 114 having a durometer lower than the primary layer and that interfaces with the mating structure, and a secondary mold feature 120, such as a barbed fastener or snap, that secures the multi-layer polymer component 101 tightly against the mating structure. According to one embodiment, the sealed interface is achieved by incorporating a heat expandable sealant in the at least one additional layer. According to one embodiment, the heat expandable adhesive material is capable of bonding with a mating surface upon the application of heat when the secondary mold feature is received in a mating structure. The multi layer component is sealed to the mating structure when the secondary mold feature is mated with the mating structure and heat is applied.

According to one embodiment, a rigid frame component may be formed from the multi-layer length of material 105 including a primary layer 110 and at least one additional layer 112 including a stiffening layer having a higher durometer that maintains a rigid component shape. According to one embodiment, the rigid frame component is suitable for supporting additional components.

According to another embodiment, an adhesive component may be formed from the multi-layer length of material 105 including a primary layer 110 and at least one additional layer 114 of adhesive material capable of bonding with a mating surface of the mating structure. According to one embodiment, the adhesive material is capable of bonding with a mating surface by application of heat or high frequency excitation sufficient to thermoset a resin adhesive when the secondary mold feature 120 is received in a mating structure. According to one embodiment, the adhesive material is capable of bonding with a mating surface by thermosetting of an epoxy adhesive when the secondary mold feature 120 is received in a mating structure to help retain the component to the mating structure and seal the interface.

According to another embodiment, an electromagnetic shield component may be formed from the multi-layered length of material 105 including a primary layer 110 and at least one additional layer formed from an electromagnetic shielding. According to one embodiment, the electromagnetic shield material may formed from a metallic mesh. According to one embodiment, the electromagnetic shield material may be formed from a conductive epoxy material. According to one embodiment, the multi layer component 101 is suitable for shielding electromagnetic waves such as from a AM or FM radio signals or mobile communication systems.

According to another embodiment, an electrically conductive component may be formed from the multi layer length of material including a primary layer 110 and at least one additional layer 112 formed from a metallic foil or a polymer composition modified to include electrically conductive materials that enable the multi layer component 101 to become electrically conductive. According to one embodiment, the at least one additional layer 112 includes a conductive thermoplastic material. According to another embodiment, an electrically conductive component may be formed from the multi layer length of material including at least the primary layer 110 being formed from a conductive thermoplastic material.

FIG. 21 is an illustration of an embodiment of a section molding operation. In this embodiment, the section mold 400 includes a plurality of pressing units 410 and a plurality of dies 420. A multi-layer length of material 105 is simultaneously zone heated along a plurality of positions along its length, providing a plurality of molten zones 35. A plurality of section molded portions 120 are formed simultaneously according to this embodiment, reducing processing time.

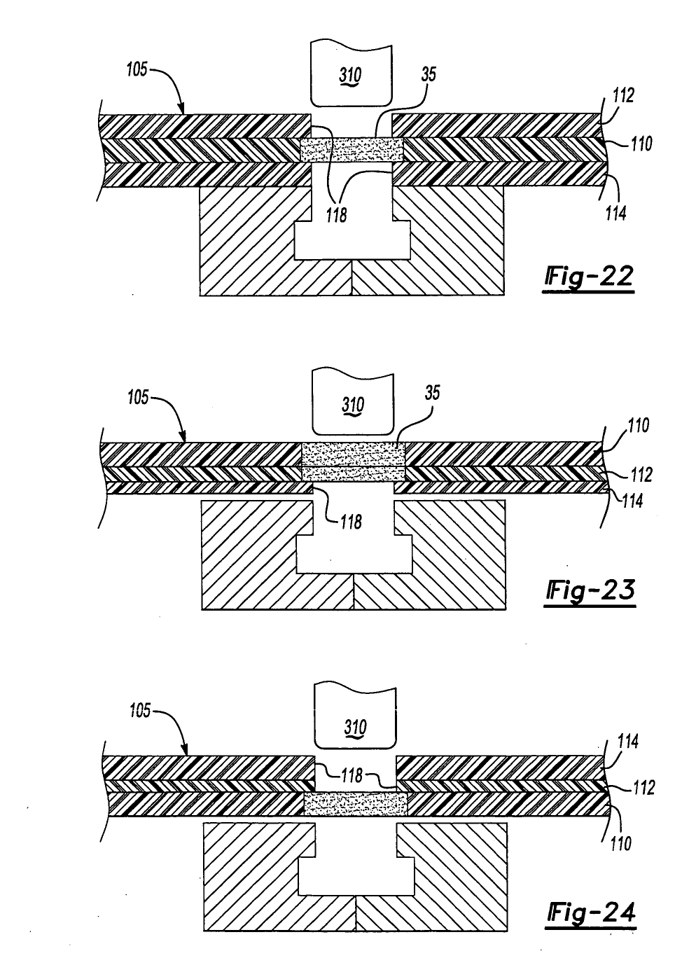

FIG. 22 illustrates an embodiment in which the primary layer 110 is centrally located within the multi layer length of material 105 with additional layers 112, 114 above and below the multi-layer length of material surrounding the primary layer 110. According to one embodiment, only the primary layer 110 includes the molten zone 35, and the section mold feature 120 is formed from the primary layer 110 only.

FIG. 23 illustrates an embodiment in which the multi-layer length of material 105 includes a molten zone 35 through the primary layer 110 and at least one additional layer of material 112 and an aperture 118 in at least one additional layer 114 of material 114. Here, at least two layers include the molten zone 35, and the section mold feature 120 is formed from the primary layer 110 and the at least one additional layer 112 having the molten zone 35.

FIG. 24 illustrates an embodiment in which the multi-layer length of material 105 includes an aperture 118 in the at least one additional layer, here aligned above the molten zone 35. According to another embodiment, the upper layer 114 may include a molten zone 35 and the primary layer 110 may include a molten zone 35, with the middle layer having an aperture 118 surrounded by the molten zones 35 in the surrounding layers. According to one embodiment, the middle layer 112 having the aperture 118 is a metallic material.

FIG. 31 illustrates a the portion of the multi layer length of material 105 having the molten zone 35 in more detail. Thermal gradients 37 extend through the at least one layer, including the primary layer 105 and transition between the surrounding solid state portion of the multi layer length of material 105 and the molten zone portion 35.

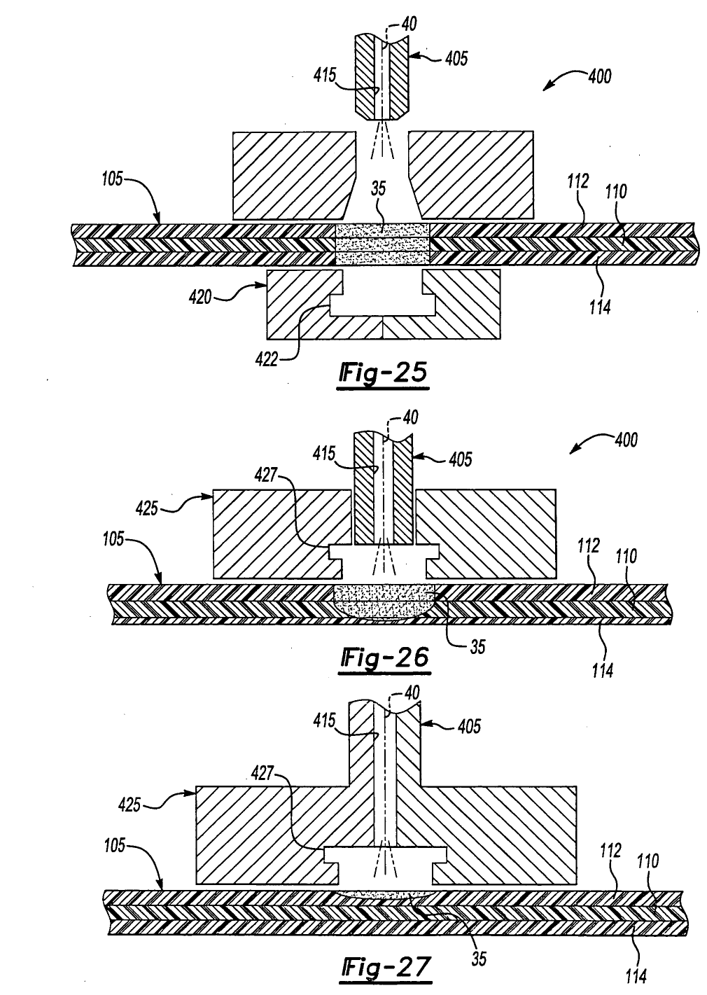

FIG. 25 illustrates a cross sectional view of an embodiment of a section mold unit 400 in which a nozzle 405 replaces the pressing unit 410 in the previous embodiments of the section mold unit 400. The section mold unit 400 of this embodiment includes a nozzle 405 with a pressurized passage 415 and a die 420 having a die cavity 422. In this embodiment, both the nozzle 405 and the die 420 are held in a stationary position. At least a portion of the primary layer 110 includes a molten zone 35. Once the portion of the primary layer 110 having the molten zone 35 is aligned over the die cavity 422, the nozzle 405 injects additional viscous material 40 into the molten zone 35 to exert a force on the material in the molten zone 35 until the additional viscous material 40 and molten zone 35 in the multi-layered length of material 120 combine and take the shape of the die cavity 422. In this embodiment, the nozzle 405 and die 420 are positioned on opposing sides of the primary layer 110. According to one embodiment, the die 420 may be provided in the form of a split die having a combined shape corresponding to the outer shape of a barbed projection to be section molded from at least the primary layer 110. Once the section mold feature is formed, the split die is separated to release the multi-layer length of material.

FIG. 26 is a cross sectional view of an embodiment of a section mold unit 400 including a nozzle 405 and a die 425 in which the nozzle 405 and die cavity 427 are positioned on the same side of the primary layer 110. The die 425 includes an opening for receiving the additional viscous material 40 from the pressurized passage 415 of the nozzle 405. In this embodiment, both the nozzle 405 and the die 425 are held in a stationary position. At least a portion of the primary layer 110 includes a molten zone 35. Here, the molten zone 35 extends through several layers of the multi-layered material 120 in addition to extending through the primary layer 110. Once the portion of the primary layer 110 having the molten zone 35 is aligned over the die cavity 427, the nozzle 405 injects additional viscous material 40 into the molten zone 35 to exert a force on the material in the molten zone 35 until the additional viscous material 40 and molten zone 35 in the multi-layered length of material 120 combine and take the shape of the die cavity 427. According to one embodiment, the die cavity 427 may be formed from a split die 425 having a combined shape corresponding to the outer shape of a barbed projection to be section molded from the primary layer 110, and the nozzle 405 may be provided to be comprised of an upper nozzle on the same side of the multi-layered material as the die cavity 427. Once the section mold feature 20 is formed, the split die 425 is separated to release the multi-layer length of material.

FIG. 27 is a cross sectional view of an embodiment of a section mold unit 400 in which a pressurized passage 406 is integral with the die cavity 427 and in which the pressurized passage 406 and die cavity 427 are positioned on the same side of the primary layer 110. The die cavity 427 includes an opening for receiving the additional viscous material 40 from the pressurized passage 406. In this embodiment, both the nozzle 405 and the die 420 are held in a stationary position. At least a portion of the primary layer 110 includes a molten zone 35. Here, the molten zone 35 extends through only a portion of the primary layer 110 improving processing time for creating the section molded portion. Once the portion of the primary layer 110 having the molten zone 35 is aligned over the die cavity 422, the nozzle 405 injects additional viscous material into the molten zone 35 to exert a force on the material in the molten zone 35 until the additional viscous material 40 and molten zone 35 in the multi-layered length of material 120 combine and take the shape of the die cavity 427. According to one embodiment, the die cavity 427 may be provided in a split die having a combined shape corresponding to the outer shape of a barbed projection to be section molded from the primary layer 110. Once the section mold feature 20 is formed, the split die is separated to release the multi-layer length of material 120.

The section mold unit 400 may be provided to include a plurality of identical die cavities. According to another embodiment, the section mold unit 400 may include at least one die cavity different from at least one other die cavity to form a section mold feature shape different from at least one other section mold feature.

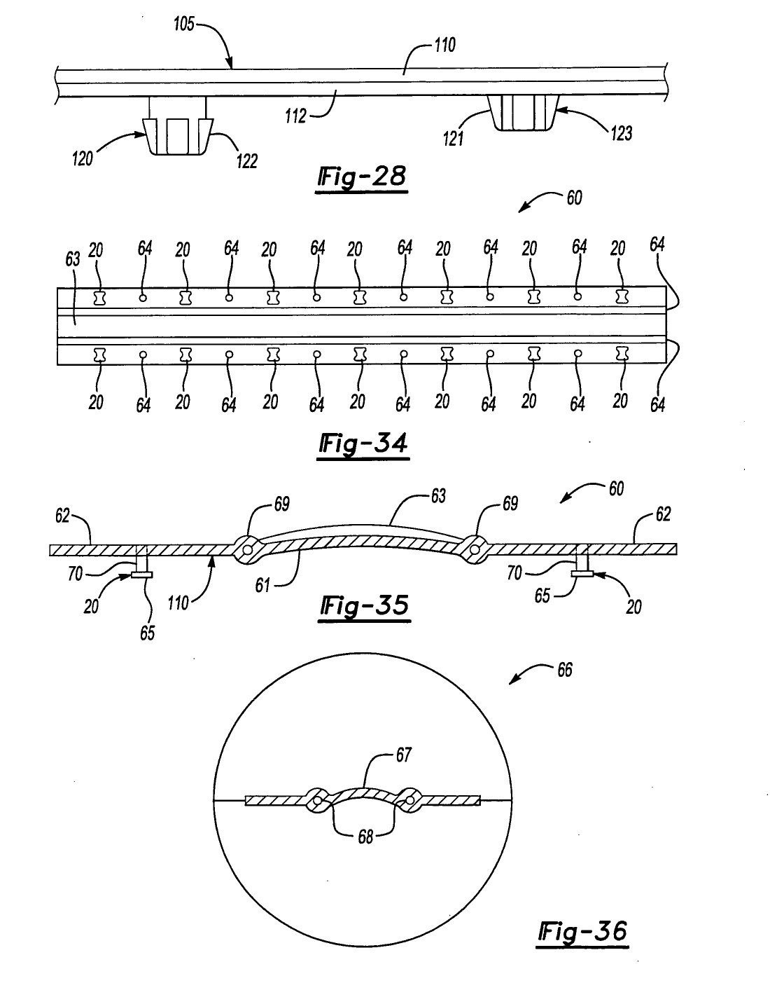

FIG. 28 illustrates an embodiment of the exemplary multi-layered component 101 in which a first section mold feature 120 is adapted to retain the multi-layered component 101 to a mating structure and a second section mold feature 121 is adapted to retain the primary layer 110 to at least one additional layer 112. In this embodiment, the first section mold feature 120 extends from the multi-layered component terminating at an end located distal 122 from an outer layer of the multi-layer material. The second section mold feature 121 is capable of retaining at least one additional layer in fixed relation to the primary layer with an end terminating adjacent 123an outer layer of the multi-layered component. This provides a method for retaining the layers of the multi-layer length of material 105 in relation to one another without requiring a separate means for coupling the layers such as adhesive, heat bonding or mechanical fasteners including without limitation, staples.

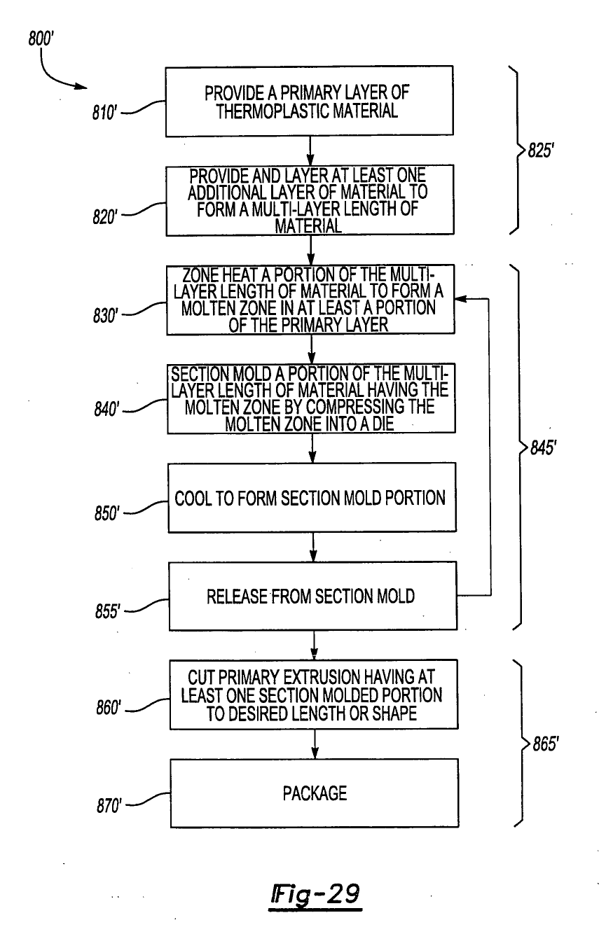

FIG. 29 is an embodiment of the process of the present invention 800′ for forming a multi-layer component 101 including a primary layer 110, at least one additional layer 112, and at least one section molded feature 120 formed from at least the primary layer 110. The procedure 800′ includes: providing a primary layer 110 of thermoplastic material 810′ and also providing and layering at least one additional length of material 112 onto the primary layer 820′. The procedure for section molding 845′ includes zone heating a portion of the multi-layer length of material 105 to form a molten zone 35 in at least a portion of the primary layer 110′, leaving the surrounding portions of the multi-layered length of material 105 in a solid state 830′. According to one embodiment, the procedure for section molding includes compressing or forcing the molten zone to the desired shape 840′ and allowing it to cool to a solid state 850′. According to one embodiment, the procedure for section molding includes adding additional molten material to the molten zone under pressure until the material combines to take the desired shape 840′ and allowing the section mold feature to cool to a solid state 850′. The section molded portion 20 is then released from the section mold unit 855′. The packaging process 865′ includes cutting the polymeric component to the desired length 860′ to form the exemplary component 1, described herein, and dropping the exemplary component 1 directly into a package 870′ for shipping. According to one embodiment, the steps described in process 800′ occur in-line. In another embodiment, the primary layer 110 having at least one section molded feature 120 can be cut to a desired shape.

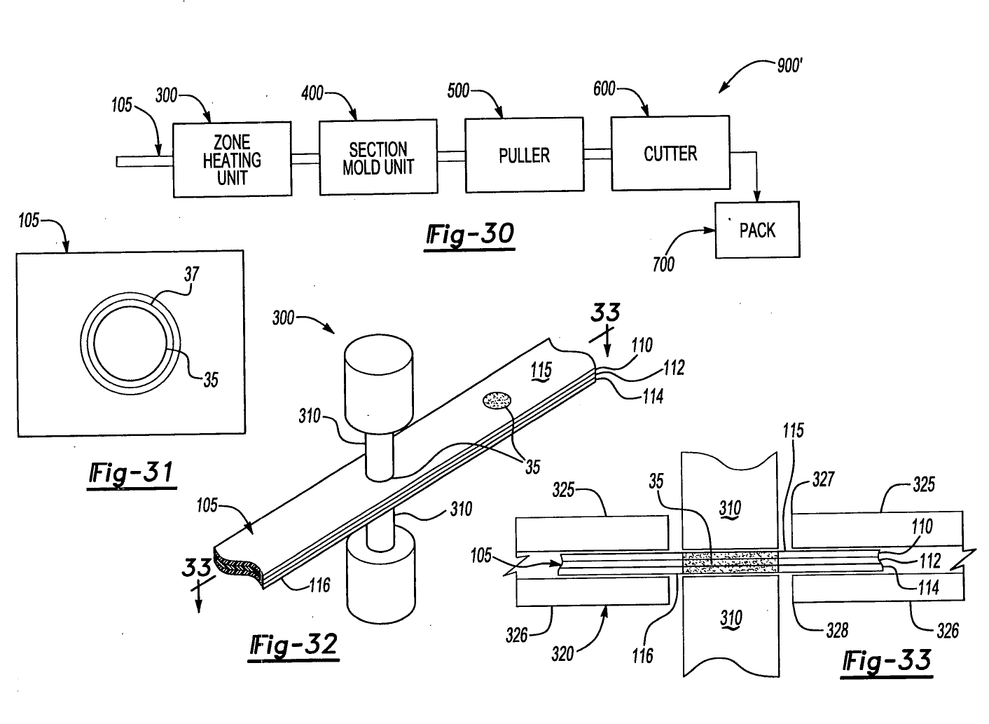

FIG. 30 is a schematic representation of an embodiment of an apparatus 900′ that performs the process of the present invention 800′ in-line. The apparatus 900′ forms the exemplary component 101 described herein with lower cycle time than can be accomplished with other methods. A multi-layered material 105 is fed into a zone heating unit 300. The zone heating unit 300 is utilized to zone heat a portion of the multi layer length of material 105 to form a molten zone in at least the primary layer 110, leaving the surrounding portions in a solid state. The in-line process of this embodiment, does not require a conveyer to carry the multi-layered material 120. Instead, a puller 500 acts on a portion of the multi-layered material 120 to pull the continuous multi-layered material 120 through the zone heat unit 300 and then on to the section mold unit 400 as it exits the zone heating unit 300. According to one embodiment, the section mold unit 400 compresses the molten zone portion 35 into a die cavity using a mandrel until the molten zone 35 takes the desired shape. According to another embodiment, the section mold unit 400 adds additional molten material under pressure to the molten zone until the molten material combines to take the shape of a die cavity. The section mold feature is allowed to cool to a steady state before being released from the die cavity. Pullers are generally known in the art and typically include an upper re-circulating track and a lower re-circulating track that pull an extrusion through frictional contact between surfaces of the tracks and the extrusion. According to this embodiment, the multi-layered material 105 is processed in one continuous piece through the zone heating unit 300, through the section mold unit 400, through the puller 500, until reaching the cutter 600 where it is cut to form the final multi-layered component 101, and dropped into the package. The puller in this embodiment utilizes a soft foam belt that conforms to some degree around the section molded portion 120. The arrangement of the zone heating unit 300, section mold unit 400, puller 500, and cutter 600 eliminates the need for a conveyer and reduces cycle time by providing direct feed from one unit to another.

According to one embodiment, the zone heating step and compression or forcing step, are performed in an off-line operation. Alternatively, the heating, cooling, zone heating and compressing or forcing steps may be aligned in an in-line operation.

According to one embodiment, a multi-layer length of material has a primary layer with a central portion with at least one additional central layer and side extensions having only the primary layer and secondary mold features. According to one embodiment, the at least one additional central layer of thermoplastic elastomer is a Sanoprene™ type of material having greater rigidity and a lower coefficient of friction but reduced thickness compared to the primary layer.

FIG. 34 illustrates a top view of an embodiment of a coextruded multi layer polymer component 60 in which the primary layer 110 is a coextrusion consisting of a central portion 61 coextruded with side extensions 62 and also at least one additional central layer 63. According to one embodiment, the primary layer 110 is a coextrusion of a central portion 61 of thermoplastic elastomer such as a Sanoprene™ type of material, with side extensions 62 of a talc-filled polypropelene material such as 20% talc-filled polyproplene, and also coextruded with at least one additional central layer 63 of a thermoplastic elastomer such as a Sanoprene™ type of material. According to one embodiment, the at least one additional central layer 63 is a Sanoprene™ type of material has a lower coefficient of friction, greater rigidity but a reduced thickness compared to the primary layer central portion so that it bends easily and does not stick create friction with a contacting surface. According to one embodiment, the coextruded multi layer component 60 is a hinge cover on a vehicle. According to one embodiment, the component 60 is suitable for use as a hinge cover for a tonneau cover for a pick-up bed. The at least one additional central layer 63 has a lower coefficient of friction, greater material rigidity but reduced thickness compared to the primary layer 110 central portion 61. The central portion 61 of the primary layer and the at least one additional layer form the portion covering the hinge in the mating structure. The side extensions 62 include at least one section mold feature 120 that forms a snap suitable for snapping into an aperture in the tonneau cover on each side of the hinge. According to one embodiment, the section mold feature 20 is used to position the hinge cover 60 while fastener means are used to additionally secure the hinge cover to the tonneau cover on each side of the hinge. According to one embodiment, the fastener means includes without limitation rivets or bolts installed through apertures 64 in the hinge cover 60, staples or other mechanical means. According to one embodiment, the section mold portions 120 have an essentially hour glass cross section when viewed from the bottom of the component. The distal bottom portion 65 of the section mold feature also has an hour glass shape cross section extending outward of the upper portion 70 of the section mold feature 20. The distal bottom portion 65 elastically deforms as it is pressed through an aperture in the mating structure and substantially returns to its original shape once through the aperture to retain the component 60 to the mating structure.

FIG. 35 illustrates a cross section of the hinge cover 60 of the type shown in FIG. 34. According to one embodiment, the hinge cover 60 central portion 61 and at least one additional central layer 63 have an arced shape. The side extensions 62 are essentially flat. The primary layer 110 central portion 61 is coextruded to the side extensions 62 with a bulb shape interface 69 that acts as a bendable joint when the sides of the mating structure rotate about the hinge.

FIG. 36 illustrates a cross section of a mold 66 for coextruding the component 60 of FIG. 34. The mold 66 includes a cavity 67 having mandrels 68 where the central portion 61 of the hinge cover 60 is coextruded with the side portions 62 to form the bulb shape interface 69 which acts as a joint.

It is contemplated that at least the primary layer 110 of the multi-layer length of material 105 will be formed of a thermoplastic material including without limitation 20% talc-filled polypropylene, talc-filled polypropelene, polyethylene, soft or rigid TPE, nylon, ABS/PVC, and a conductive thermoplastic material. Although exemplary multi-layer components are described, a variety of other components may be produced utilizing the apparatus and method described herein by varying the shape of an of the primary layer 110, the at least one additional layer 112, or the section molded features 120, 123.

The process used to form the exemplary components of the present invention, provides short cycle time, can be quickly adapted to design changes, and can be entirely automated.

While the present invention has been described with reference to exemplary components, a variety of components may be produced utilizing the apparatus and process described herein. Modifications and variations in the invention will be apparent to those skilled in the art in light of the foregoing description. It is therefore contemplated that the appended claims and their equivalents will embrace any such alternatives, modifications and variations as falling within the scope of the present invention.

1. A method of forming a multi-layer component, comprising:
providing a multi-layer length of material in a solid state having a primary layer of thermoplastic material and at least one additional layer;
zone heating at least one layer including the primary layer to create a molten zone portion in the at least one layer, leaving surrounding portions of the multi-layer length of material in a solid state;
forcing the molten zone portion into a die cavity until the at least one layer takes the shape of the pressing unit and die cavity and forms a solid state section molded feature integral with the at least one layer; and
cutting a length of material including the molded feature to a final shape.

2. The method of claim 1 the step of providing a primary layer of thermoplastic material further comprising:
heating a polymeric compound and forcing the heated compound through an orifice to form a heated layer; and
cooling the heated layer to form a primary layer in a solid state.

3. The method of claim 1 further comprising:
aligning the zone heating and compression steps in an off-line operation; and
forming the section molded portion in the off-line operation.

4. The method of claim 1 further comprising:
aligning the heating, cooling, zone heating and forcing steps in an in-line operation; and
forming the section molded portion in the in-line operation.

5. The method of claim 1 the step of zone heating at least one portion, further comprising:
applying zone heating of the type selected from the group consisting of:
convection heating, radiant heating, conduction heating, infrared heating, and induction heating.

6. The method of claim 1 further comprising:
providing a section mold unit having at least one pressing unit and at least one die cavity for forming a section molded feature integral to the multi-layer length of material; and
aligning the at least one molten zone with a corresponding die cavity of the section mold in preparation of forcing the molten zone.

7. The method of claim 6 further comprising:
providing the die cavity to be comprised of a split die having a combined shape corresponding to the outer shape of a barbed projection to be section molded from the primary layer,
providing the pressing unit to be comprised of an upper mandrel having a shape corresponding to the inner shape of the barbed projection; and
raising the mandrel and separating the split die to release the multi-layer component.

8. The method of claim 1 further comprising:
clamping the solid state portion of the multi-layer length of material to stabilize the primary layer prior to forcing the molten zone.

9. The method of claim 1 the step of zone heating at least one portion, including:
simultaneously zone heating a plurality of portions along the length of the multi-layer length of material to simultaneously create a plurality of molten zones, leaving the surrounding portions of the multi-layer length of material in a solid state;
providing a section mold having a plurality of die cavities and pressing units; and
aligning each portion of the multi-layer length of material having a molten zone with a corresponding die cavity of the section mold.

10. The method of claim 1 further comprising:
providing a section mold unit including a plurality of identical die cavities.

11. The method of claim 11 further comprising:
providing a plurality of die cavities and pressing units and wherein at least one die cavity define a section mold feature shape different from at least one other die cavity.

12. The method of claim 1 the step of zone heating at least one portion, including:
zone heating a first portion of the multi-layer length of material to create a molten zone within the first portion, while leaving the remaining portion of the multi-layer length of material in a solid state;
providing a section mold having a die cavity and pressing unit;
aligning the molten zone of the first portion with the die cavity;
forcing the first portion between the pressing unit and die cavity until the first portion takes the shape defined by the die cavity and pressing unit and forms a solid state integral with the multi-layer length of material;
advancing the multi-layer length of material;
zone heating a second portion of the multi-layer length of material to create a molten zone within the second portion, leaving the surrounding portion of the multi-layer length of material in a solid state;
aligning the molten zone of the second portion with the die cavity; and
forcing the second portion between the pressing unit and the die cavity until the second portion takes the shape defined by the die cavity and pressing unit and forms a solid state integral with the multi-layer length of material.

13. The method of claim 11 further comprising:
providing at least one die cavity and pressing unit shaped to form a first section mold feature having a central portion extending from the primary layer beyond the outer layer and terminating in a barbed projection located distal from an outer layer of the multi-layer material.

14. The method of claim 13 further comprising:
providing at least one die cavity and pressing unit that define a second section mold feature capable of retaining at least one additional layer in fixed relation to the primary layer.

15. The method of claim 13 further comprising:
providing at least one die cavity and pressing unit shaped to form a second section mold feature having a central portion extending from the primary layer, through at least one adjacent layer, and terminating in a barbed projection.

16. The method of claim 1 further comprising:
forming the multi-layer length of material by applying adhesive between the primary layer and at least one other layer.

17. The method of claim 1 further comprising:
forming the multi-layer length of material by applying a mechanical fastener to retain the primary layer and at least one other layer.

18. The method of claim 17 the step of applying a mechanical fastener comprising:
stapling the primary layer and at least one other layer to one another.

19. The method of claim 1 further comprising:
forming the multi-layer length of material by heat bonding the primary layer at least one other layer.

20. The method of claim 1 further comprising:
forming the multi-layer length of material to include at least one additional layer including an outer layer having a durometer lower than the primary layer suitable for an anti-rattle interface with a mating structure when the secondary mold feature is received in a mating structure.

21. The method of claim 1 further comprising:
forming the multi-layer length of material to include at least one additional layer including an outer layer of adhesive material capable of bonding with a mating surface upon the application of heat when the secondary mold feature is received in a mating structure.

22. The method of claim 1 further comprising:
forming the multi-layer length of material to include at least one additional layer including an outer layer of sealing material suitable for providing a sealed interface with a mating structure when the secondary mold feature is received in a mating structure.

23. The method of claim 1 the step of providing a multi-layer length of material including providing at least one layer of electrically conductive material in the at least one additional layer.

24. The method of claim 23 the step of providing at least one layer of electrically conductive material including providing at least one layer of metal.

25. The method of claim 24 the step of providing a multi-layer length of material including providing at least one layer of metal forming an electromagnetic shield layer in the at least one additional layer.

26. The method of claim 24 the step of providing a multi-layer length of material including providing at least one layer of foil to form foil layer in the at least one additional layer.

27. The method of claim 23 the step of providing a multi-layer length of material including providing at least one layer of electrically conductive plastic in the at least one additional layer.

28. The method of claim 1 further comprising:
providing the at least one additional layer including at least one portion having an aperture and forming at least one section mode portion by aligning the zone heating element with the portion having the aperture.

29. The method of claim 1 further comprising:
providing a section mold unit having at least one pressurized passage and a die cavity, and
forcing additional molten thermoplastic material into the molten zone and directed into the die cavity until the additional molten thermoplastic and molten zone take the shape of the die cavity.

30. The method of claim 29 wherein the step of providing the at least one pressurized passage and die cavity further comprise:
providing the at least one pressurized passage positioned opposite the die cavity so that the pressurized passage and the die cavity are on opposite sides of the primary layer.

31. The method of claim 29 wherein the step of providing the at least one pressurized passage and die cavity further comprise:
providing the pressurized passage opening into the die cavity so that the pressurized passage and die cavity are on the same side of the primary layer.

32. The method of claim 1 wherein the step of zone heating further comprises:
zone heating less then the entire thickness of the primary layer reducing processing time.

33. A multi-layered polymeric component, comprising:
a primary layer being formed least in part by thermoplastic material; and
at least one additional layer of material fixedly attached to the primary layer; and
at least one section molded portion formed by the process of zone heating a portion of at least the primary layer to create a molten zone and forcing the portion having the molten zone in a die cavity until the molten zone takes the shape of the die cavity and forms a solid state, the at least one section molded portion capable of interconnection with an aperture in a portion of a mating structure and having suitable rigidity to retain the primary layer relative to the structure.

34. The multi-layered polymeric component of claim 33 further comprising:
the section molded portion formed integral with only the primary layer and aligned with an aperture portion of the at least on additional layer.

35. The multi-layered polymeric component of claim 33 further comprising:
the section molded portion formed integral with the primary layer and at least one additional layer of thermoplastic material.

36. The multi-layered polymeric component of claim 33 further comprising:
the section molded portion being in the shape of a barbed projection having a first outer diameter extending from the primary layer and a second outer diameter greater than the first outer diameter and distal from the primary layer.

37. The multi-layered polymeric component of claim 33 further comprising:
a first section molded feature terminating at an end distal from an outer layer of the multi-layered material.

38. The multi-layered polymeric component of claim 37 wherein the first section molded feature terminates at an end forming a barbed projection suitable for retaining the multi-layered polymeric component relative to a mating structure.

39. The multi-layered polymeric component of claim 37 further comprising:
a second section molded feature capable of retaining at least one additional layer in fixed relation to the primary layer.

40. The multi-layered polymeric component of claim 39 wherein the second section molded feature terminates in a barbed projection having a portion extending through the at least one additional layer and a portion having a greater outside diameter interfacing with and extending beyond the at least one additional layer retaining the primary layer and the at least one additional layer relative to one another.

41. The multi-layered polymeric component of claim 33 further comprising:
the primary layer formed by the process of heating a polymeric compound and forcing the heated compound through an orifice to form a heated layer; and
cooling the heated layer to form the primary layer in a solid state.
